(19) United States
(12) Patent Application Publication
(10) Pub. No.: US 2012/0154938 A1
(43) Pub. Date: Jun. 21, 2012

(54) LENS DRIVE DEVICE, AND CAMERA MODULE AND PORTABLE TELEPHONE WHICH HAVE THE LENS DRIVE DEVICE MOUNTED THEREIN

(75) Inventors: Suguru Ohishi, Moriguchi-shi (JP); Hiroshi Yamashita, Ichinomiya-shi (JP); Mituo Nakashima, Neyagawa-shi (JP); Seigo Yamanaka, Gifu-shi (JP); Yuma Aoi, Ichinomiya-shi (JP); Koji Nishikawa, Tsuyama-shi (JP)

(73) Assignee: SANYO ELECTRIC CO., LTD., Moriguchi-shi, Osaka (JP)

(21) Appl. No.: 13/392,980

(22) PCT Filed: Aug. 24, 2010
(86) PCT No.: PCT/JP2010/064307

§ 371 Date: Feb. 28, 2012

(30) Foreign Application Priority Data
Sep. 2, 2009 (JP) 2009-202822

(51) Int. Cl. G02B 7/04

(52) U.S. Cl. 359/824

(57) ABSTRACT

A lens driving device suppresses inward deformation of posts when the winding of a conductive wire generates a winding pressure. A lens driving device 1 includes a holder 10 that holds a lens unit 13. The holder 10 is movable in an optical axis direction of the lens unit 13. A magnet 20 surrounds the lens unit 13 in a radial direction of the lens unit 13. The magnet 20 is fixed to the holder 10. A coil 60 surrounds the holder 10 in the radial direction. The coil 60 faces the magnet in the radial direction. Posts surround the holder in the radial direction. The posts to which the coil is wound extends in the optical axis direction. A beam connects ends of the posts facing the same direction in the optical axis direction with each other. The beam is connected to each end of the posts.

### TECHNICAL FIELD

The present invention relates to a lens driving device that includes a holder, which holds a lens unit and is movable in an optical axis direction of the lens unit, a magnet, which surrounds the lens unit from the radial direction of the lens unit and is fixed to the holder, and a coil, which faces the magnets in the radial direction, and to a camera module and cellular phone including the lens driving device.

### BACKGROUND ART

Nowadays, typical cellular phones include camera modules. Since it is difficult to perform manual focusing with such a camera module, an automatic focusing function (autofocus) has become an essential function. A lens driving device is used to perform autofocusing with the camera module. Further, cellular phones have become thinner and more compact. This has resulted in less space that can be provided for the lens driving device. Accordingly, as a structure that drives the lens unit of a lens driving device, a structure that drives a lens unit of a lens driving device adapts a moving magnet type linear driving technique such as that described in, for example, patent document 1.

The structure adapting the moving magnet type linear driving technique is simpler than a structure using a stepping motor and can thus miniaturize the lens driving device. FIGS. 7 and 8 show one example of a lens driving device having such a structure that uses the moving magnet type linear driving technique.

As shown in FIGS. 7 and 8, magnets 120 are arranged on a holder 110, which holds a lens unit 113. A coil 160 is arranged on a base 130, which is fixed to a camera module main body. Current flows through the coil 160 to generate electromagnetic driving force. As a result, the magnets 120 arranged on the holder 110 receive force in an optical axis direction. This moves the holder 110 in the optical axis direction of the lens unit 113.

### PRIOR ART DOCUMENT

Patent Document 1: Japanese Laid-Open Patent Publication No. 2008-185749

### DISCLOSURE OF THE INVENTION

### Problems that are to be Solved by the Invention

Referring to FIG. 8, the arrangement of coils on a base 130 is normally performed by fitting the coils 60, which is preformed, to posts 132 of the base 130. However, the coil 160 and base 130, which are formed separately, are coupled. This results in the need for a gap to facilitate the fitting. The coil 160 and the base 130 each include processing tolerance. Hence, it becomes difficult to improve the processing accuracy.

Accordingly, a conductive wire can be directly wound around posts 132 of the base 130 to arrange the coil 160 on the base. By forming coils directly on the posts 132, the process of coupling discrete preformed coils to the posts 132 of the base 130 can be eliminated. Further, a jig for coil formation does not have to be prepared. This lowers costs. However, the winding pressure of the conductive wire applies force F, which acts inward in the radial direction (hereinafter simply referred to as “inward”) as viewed in FIG. 9, to each post 132. This may inwardly deform the posts 132 toward each other and lower accuracy.

In light of the situation described above, it is an object of the present invention to provide a lens driving device that directly winds a conductive wire to posts of a base to arrange a coil on the base and thereby prevent the winding pressure generated when winding the conductive wire from inwardly deforming the posts. It is also an object of the present invention to provide a camera module including the lens driving device and a cellular phone including the camera module.

### Means for Solving the Problem

A lens driving device according to the present invention includes a holder that holds a lens unit. The holder is movable in an optical axis direction of the lens unit. A magnet surrounds the lens unit in a radial direction of the lens unit. The magnet is fixed to the holder. A coil surrounds the holder in the radial direction. The coil faces the magnet in the radial direction. A plurality of posts surround the holder in the radial direction. The plurality of posts to which the coil is wound extend in the optical axis direction. A beam connects ends of the posts facing the same direction in the optical axis direction with each other. The beam is connected to each end of the plurality of posts.

In the above structure, the beam connects ends of the posts facing the same direction in the optical axis direction with each other. The beam is connected to each end of the plurality of posts. Since the beam connects the ends of the posts facing the same direction in the optical axis direction, the strength that acts against the winding pressure when the coil is wound is increased as compared with the prior art. This suppresses inward deformation of the posts when winding force is generated by winding a coil as compared with the prior art.

Preferably, in the lens driving device according to the present invention, the posts include a hooking portion that hooks an end of the coil.

In the above structure, the posts include the hooking portion that hooks an end of the coil. This easily hooks the end of a wound coil to the posts. Accordingly, unwinding of the coil is suppressed, and the electromagnetic driving force generated by the coil can be stabilized. Further, the end can easily be connected to the terminal arranged in the vicinity of the hooking portion.

Preferably, in the lens driving device according to the present invention, the posts include a direction changing portion that changes a winding direction of the coil.

In the above structure, the posts include a direction changing portion that changes a winding direction of the coil. Thus, when directly winding a coil around the posts, the winding direction of the coil can easily be changed. For example, when the coil is formed by combining two or more coils wound in different winding directions, the formation of the coil by directly winding the coil around the posts is difficult. However, the arrangement of the direction changing portion facilitates the formation of the coil by directly winding the coil around the posts even when combining two or more coils wound in different winding directions.

Preferably, in the lens driving device according to the present invention, the holder is molded integrally with the magnet.

In the above structure, the holder is molded integrally with the magnet. Thus, in comparison with when bonding the magnets and holder with an adhesive, the bonding strength of the magnets and holder can be increased. Integral molding of the holder and the magnets can easily be facilitated by, for example, injection molding a resin material. Thus, a process of coupling the magnets can be eliminated, and costs may be reduced.

A camera module according to the present invention includes the above lens driving device. In the lens driving device, even when a conductive wire is directly wound around the posts of the base, the lens driving device suppresses inward deformation of the posts when the winding of a conductive wire generates a winding pressure. Thus, the lens driving device has high accuracy. Accordingly, a camera module including the lens driving device has high accuracy.

A cellular phone according to the present invention includes the above camera module. The camera module is compact and highly accurate. Thus, the camera module is optimal for use in a cellular phone.

### Effect of the Invention

The present invention provides a lens driving device that directly winds conductive wires to posts of a base to arrange a coil on the base. The lens driving device prevents the winding pressure generated when winding the conductive wire from inwardly deforming the posts. Further, the present invention provides a camera module including the lens driving device.

### BRIEF DESCRIPTION OF THE DRAWINGS

FIG. 1 is a schematic diagram showing one embodiment of a cellular phone according to the present invention in a state in which the cellular phone is closed.

FIG. 2 schematically shows one embodiment of the cellular phone according to the present invention in a state in which the cellular phone is open, where FIG. 2(a) is a perspective view showing an inner surface and FIG. 2(b) is a perspective view showing a rear surface.

FIG. 3 is a schematic diagram showing the structure of a camera module in the embodiment of the cellular phone according to the present invention.

FIG. 4 is an exploded perspective view of a lens driving device of a camera module in the embodiment of the cellular phone according to the present invention.

FIG. 5 is a diagram showing the embodiment of the cellular phone according to the present invention, where FIG. 5(a) is a partially enlarged view showing a base of FIG. 4, and FIG. 5(b) is a further enlarged view of FIG. 5(a).

FIG. 6 is a diagram showing the embodiment of the cellular phone according to the present invention, where FIG. 6(a) is a partially enlarged view showing the base of FIG. 4, and FIG. 6(b) is a further enlarged view of FIG. 6(a).

FIG. 7 is a perspective view showing a lens driving device of the prior art in a state in which a cover is removed.

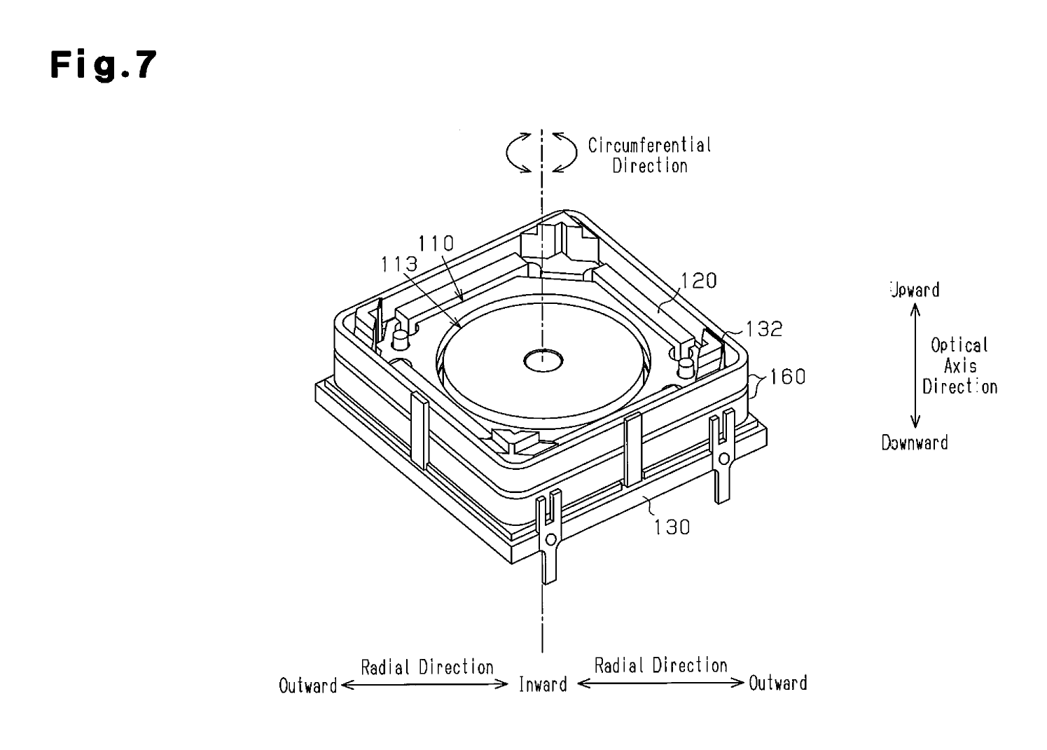

FIG. 8 is an exploded perspective view showing the lens driving device of the prior art.

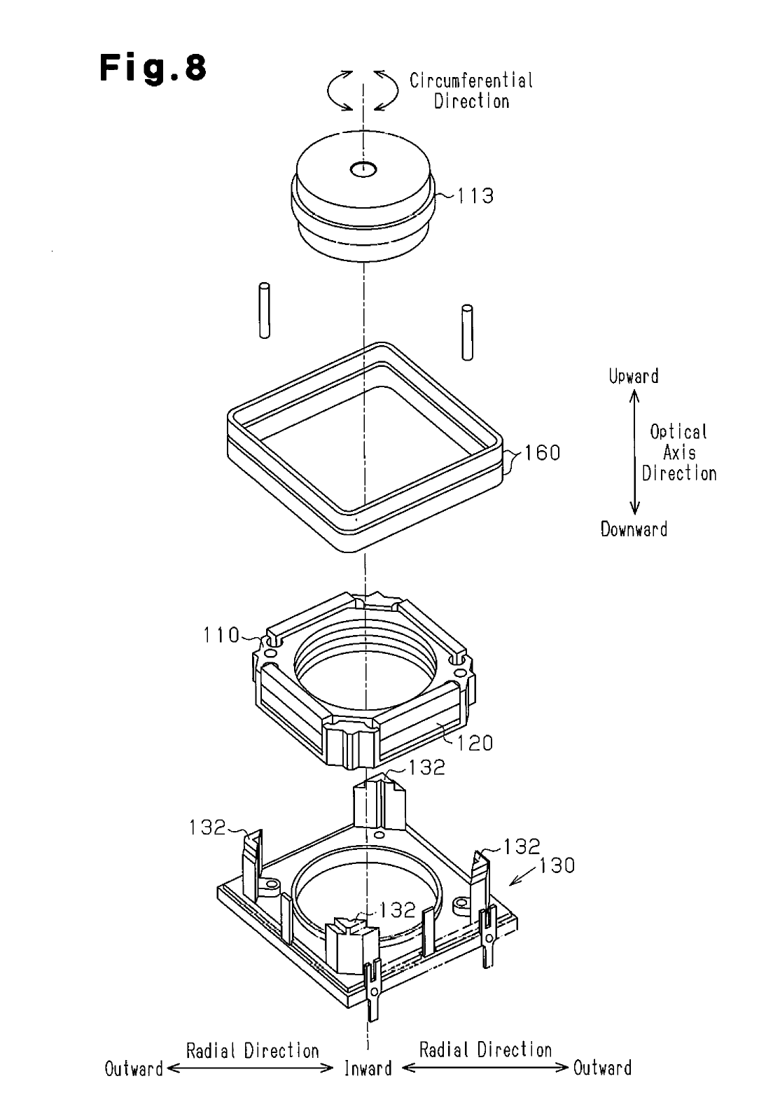

FIG. 9 is a perspective view showing the lens driving device of the prior art illustrating forces applied to posts.

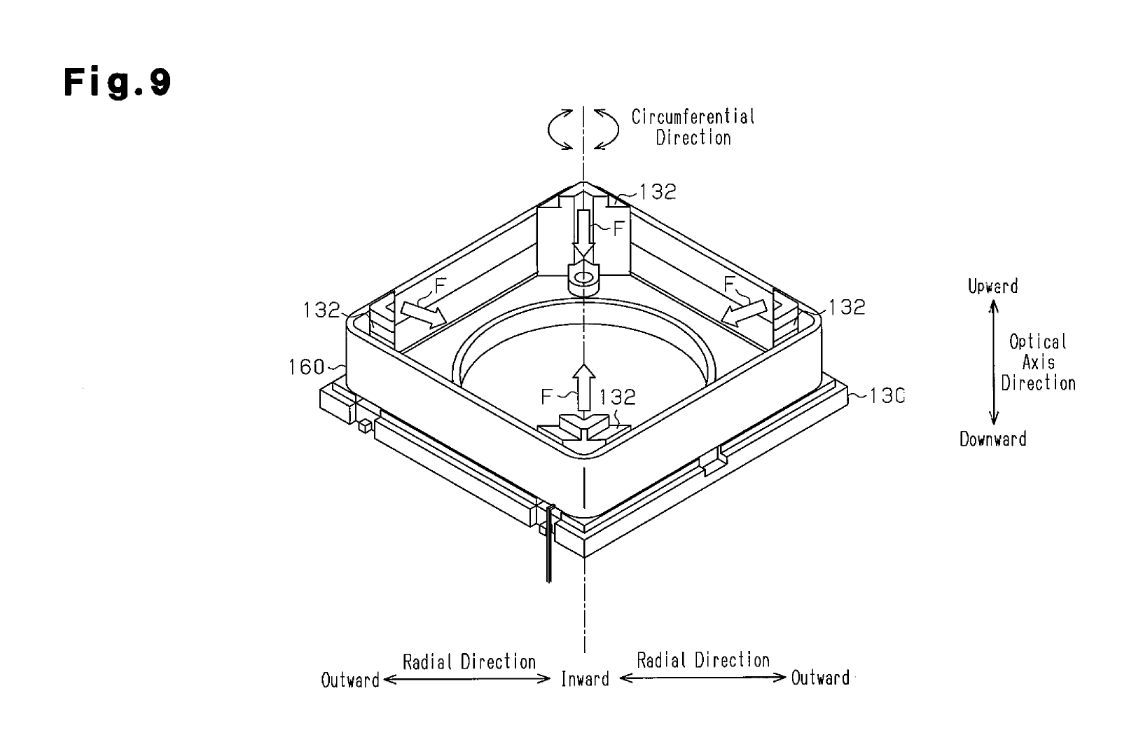

### EMBODIMENTS OF THE INVENTION

One embodiment of a cellular phone according to the present invention will now be described with reference to the drawings.

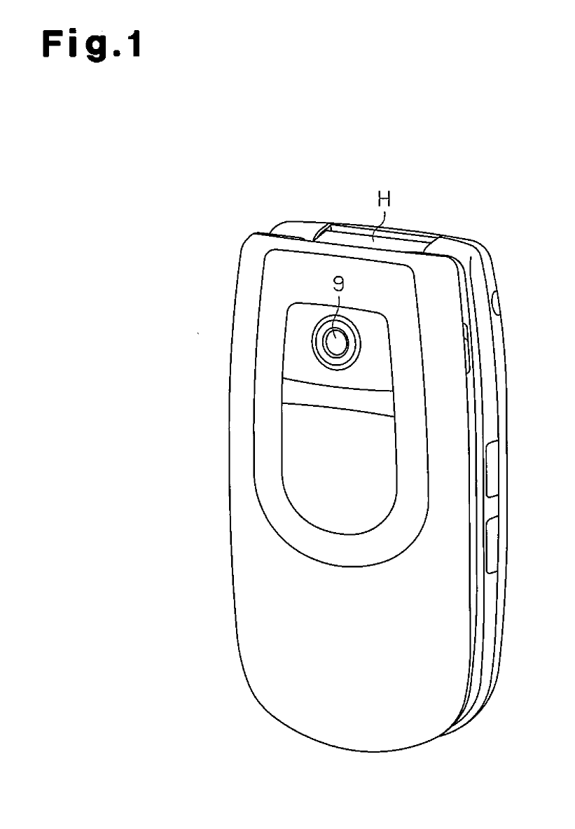

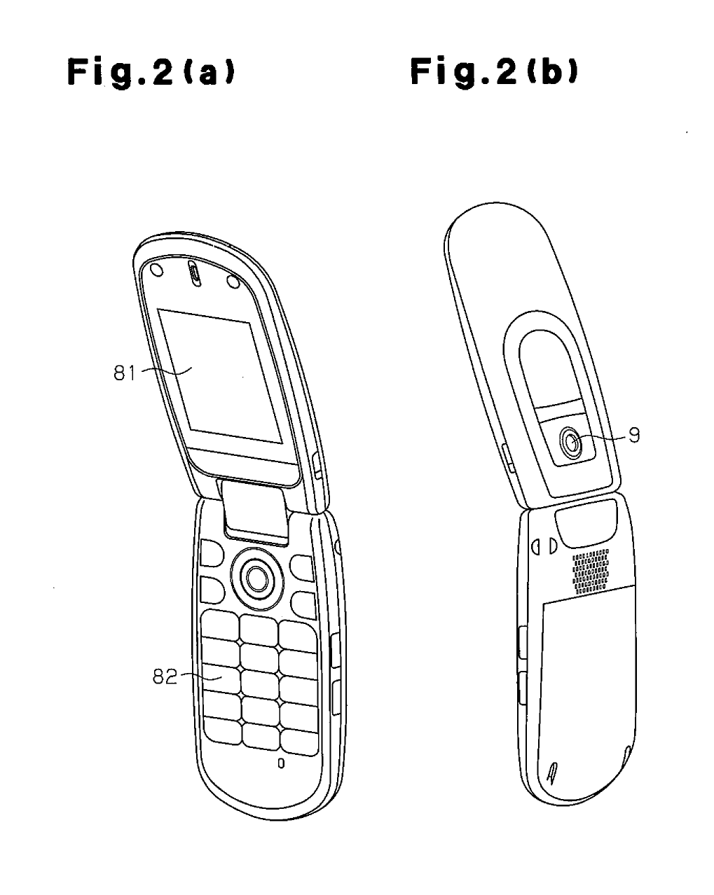

As shown in FIG. 1, the cellular phone is a phone that is folded about a hinge H. FIG. 1 is a view showing the folded state, in which a cover glass 9, which is part of a camera module, is exposed from the front surface. FIG. 2(a) is a view showing the cellular phone in an open state so that a display unit 81 and an operation unit 82 face toward the front. FIG. 2(b) is a view showing the cellular phone in an open state from the rear. To take a picture of a subject, a photographer directs the cover glass 9 towards the subject that is to be captured with the cellular phone in an open state and releases the shutter by operating the operation unit 82 while checking the image on the display unit 81.

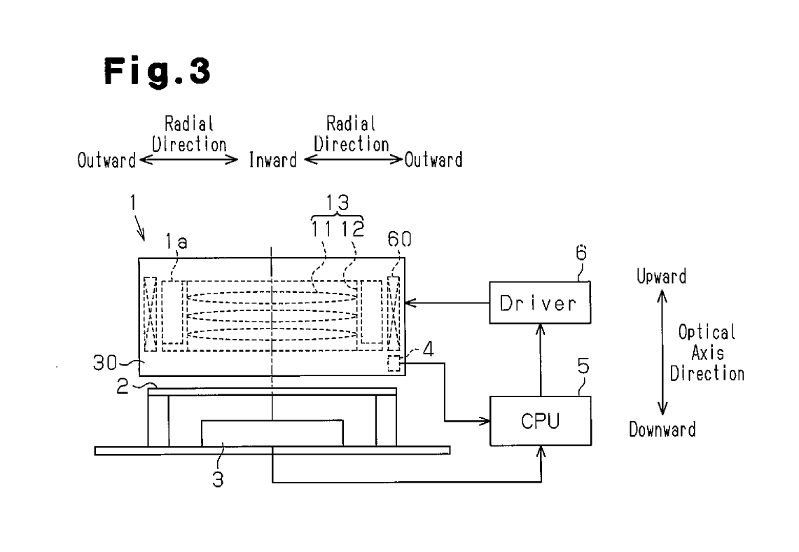

The structure of the camera module when arranging a lens driving device 1 of the present embodiment in a camera will now be described with reference to FIG. 3.

As shown in FIG. 3, a filter 2 and an image sensor 3 are arranged at a side of the lens driving device 1 that is closer to a base 30. A Hall element 4, which serves as a position detection element, is arranged on the base 30. The position of a lens module 1a is performed based on a signal from the Hall element 4.

During a focusing operation, a central processing unit (CPU) 5 controls a driver 6 to move the lens module 1a upward in an optical axis direction from a home position to a preset position. Here, the Hall element 4 sends a position detection signal to the CPU 5. At the same time, the CPU 5 processes the signal input from the image sensor 3 to acquire a contrast value of a captured image. The position of the lens module 1a at which the contrast value becomes most satisfactory is obtained as a focus position.

Then, the CPU 5 drives the lens module 1a to the focus position. Specifically, the CPU 5 monitors the signal from the Hall element 4 and drives the lens module 1a until the signal from the Hall element 4 corresponds to the focus position. This moves the lens module 1a to the focus position.

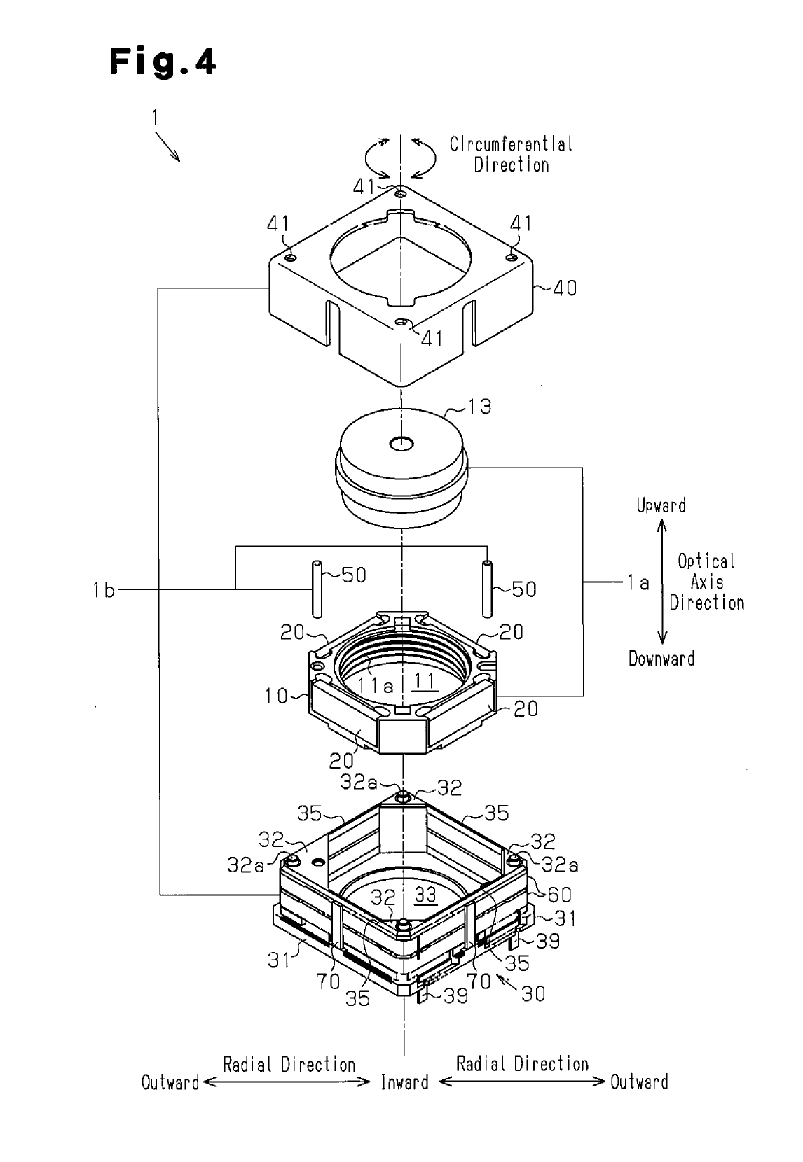

The entire structure of the lens driving device 1, which drives the lens module 1a, will now be described in detail with reference to FIG. 4.

The lens driving device 1, which is used in the camera module, includes a holder 10, which holds a lens unit and is movable in an optical axis direction of the lens unit, and magnets 20, which surround the lens unit from a radial direction of the lens unit and are fixed to the holder.

Further, the lens driving device 1 includes a coil 60, which surrounds the holder 10 in the radial direction and faces the magnets 20 in the radial direction, and a plurality of posts 32, which surround the holder 10 in the radial direction and extend in the optical axis direction. The coils are wound around the posts 32. The lens driving device 1 also includes beams that connect ends of the posts 23 facing the same direction. Each end of the posts 32 is connected to a beam.

Specifically, the lens driving device 1 includes the lens module 1a, which is movable in the optical axis direction, and a fixed body 1b, which applies driving force to the lens module 1a and is fixed to an apparatus in which the lens driving device 1 is installed. Autofocusing is performed by moving the lens module 1a in the optical axis direction with the lens driving device 1. The lens driving device 1 of the present embodiment is a square having 8.5 mm sides as viewed from above in the optical axis direction, and the lens driving device 1 has a height in the optical axis direction that is approximately 3 mm.

The lens module 1a includes a lens unit 13, which is formed as shown in FIG. 3 by a plurality of optical lenses 11 and a lens barrel 12 that holds the plurality of optical lenses 11, a holder 10, which holds the lens unit 13 and is formed from resin, and a plurality of magnets 20, which are fixed to the holder 10. In the present embodiment, four magnets 20 are fixed to the holder 10 and arranged outward in a radial direction from the lens unit 13 surrounding the lens unit 13 in a circumferential direction and separated from one another by a fixed distance in the circumferential direction. The holder 10 is formed by injection molding a resin material. In this case, the magnets 20 are attached in advance to a mold that forms the holder 10 so that the holder is molded integrally with the magnets during injection molding. Such a manufacturing process increases the bonding strength of the magnets 20 and the holder 10 as compared to when joining the magnets 20 and the holder 10 with an adhesive. This also eliminates the process of attaching the magnets 20 and reduces costs.

As shown in FIG. 4, the fixed body 1b includes the base 30 and case 40, which form an outer frame of the lens driving device 1, shafts 50, which are fixed to the base 30 and guide movement of the holder 10 in the optical axis direction, and the coil 60, which forms a magnetic field when current is applied. Magnetic plates 70, which are rectangular plate-shaped magnetic members formed from magnetic steel plates, are fixed to the base 30 outward in the radial direction from the coil 60.

The base 30 includes a basal portion 31, which forms the lower surface of the outer frame of the lens driving device 1, and the posts 32, which extend in the optical axis direction from the basal portion 31. The basal portion 31 is square when viewed from above in the optical axis direction. The supports 32 are arranged at the four corners of the basal portion 31. An opening 33, which is a circular through hole, is formed in a central position of the basal portion 31. Thus, the basal portion 31 connects the lower ends of the posts 32 with respect to the optical axis direction and thereby functions as a lower beam. Two magnetic plates 70 are fixed to the edges of the base 30 at two locations. More specifically, a magnetic plate 70 is fixed to a middle position of each side forming an edge of the base 30.

Pillars 35 connect upper ends of the posts 32 with respect to the optical direction. The pillars 35 thereby function as upper beams. In this manner, the posts 32 are each connected at their two ends by the basal portion 31 and pillars 35 that function as beams. This increases the strength that acts against the winding pressure of the wound coil 60 as compared with the prior art. Accordingly, inward deformation of the posts, which is caused by the winding pressure generated when winding the conductive wires, is suppressed as compared with the prior art.

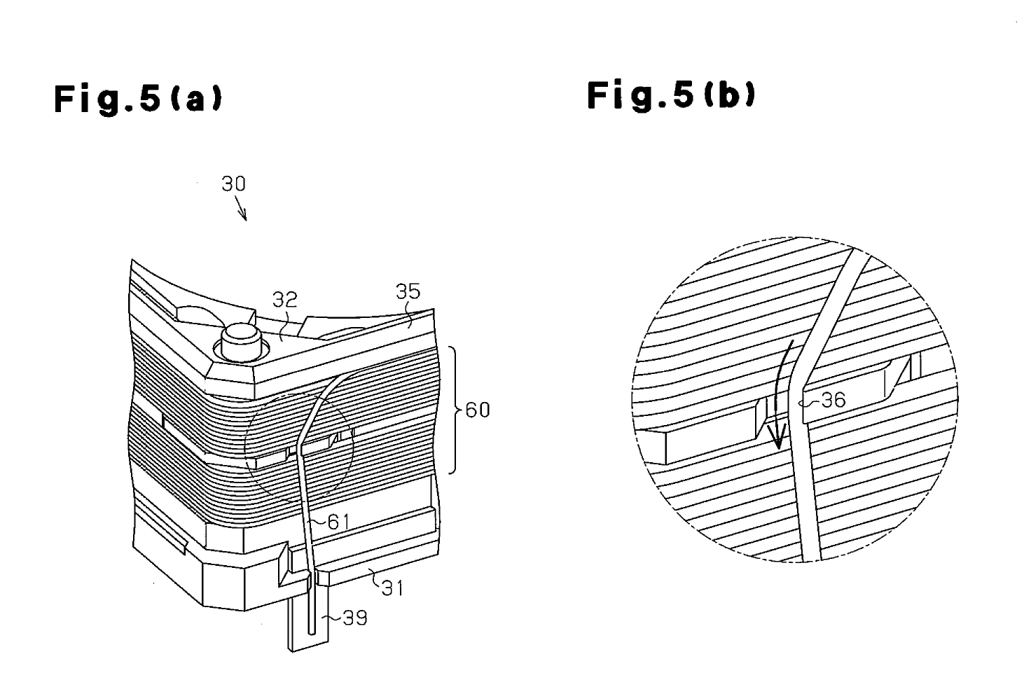

Further, the posts 32 of the lens driving device 1 include a hooking portion 36, which hooks an end of the coil 60. More specifically, referring to FIG. 5, which is an enlarged view showing one corner of the basal portion 31, the post 32 includes a hook-shaped hooking portion 36. Thus, by hooking the coil 60 to the hooking portion 36, an end 61 of the coil 60 can easily be hooked to the post 32. This prevents unwinding of the coil 60 and stabilizes the electromagnetic driving force generated by the coil 60.

In addition, the end 61 can easily be connected to a terminal arranged on the basal portion 31.

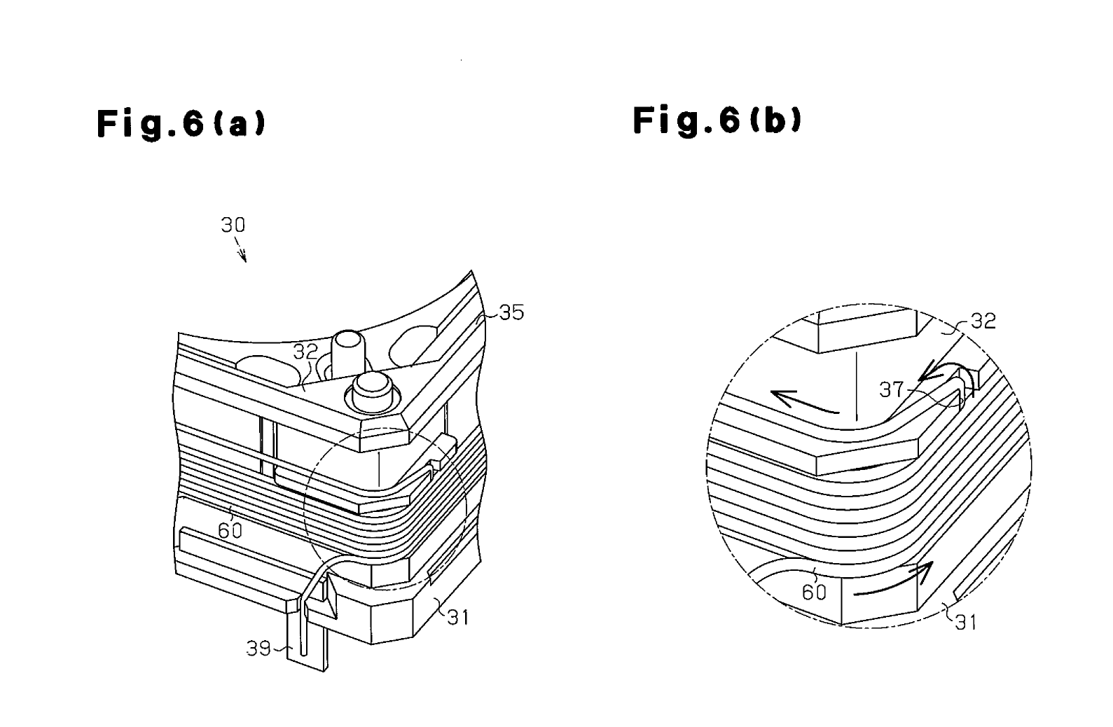

The coil 60 is formed by combining two coils wound in different winding directions. This structure easily forms a closed magnetic circuit with the magnetic field formed by the coil and the magnets 20 and allows for fine control of the electromagnetic force. Thus, the lens module 1a can be easily and accurately moved. Such a coil structure can easily be obtained when the coil 60 is formed as a discrete body but is difficult to obtain when directly forming a coil on the base 30. Accordingly, the posts 32 of the lens driving device 1 include a direction changing portions 37, which are used to change the winding direction of the coil 60 at the posts 32. More specifically, referring to FIGS. 6(a) and 6(b), which are enlarged views showing another corner of the basal portion 31, the direction changing portion 37 is hook-shaped. A conductive wire is hooked to and bent back on the hook-shaped portion. This facilitates direct winding of the coil 60, which changes winding directions, to the posts 32 in comparison with the prior art.

In this manner, the coil 60 is wound around four posts of the base 30. Thus, the application of current to the coil generates a magnetic field around the coil 60. The magnetic field and the magnets 20 generate force that moves the lens module 1a in the optical axis direction.

The shafts 50 are each fixed to the basal portion 31 of the base 30 and extended along the optical axis direction. The holder 10 is arranged so as to be slidable relative to the shafts 50. As a result, the lens module 1a becomes movable in the optical axis direction when receiving moving force in the optical axis direction and guided along the shafts 50.

Further, the case 40, which forms the outer side surfaces and upper surfaces of the lens driving device 1, is coupled to the base 30 surrounding the outer side of the coil 60 in the radial direction. The upper surface of the case 40 includes a plurality of through holes 41, into which upper ends 32a of the posts 32 with respect to the optical axis direction are inserted. In a state in which the ends 32a are inserted into the corresponding through hole 41, a lower part of the case 40 is fixed to the basal portion 31.

The lens driving device 1 of the present embodiment has the advantages described below.

(1) The present embodiment includes the basal portion 31 connecting the upper ends of the posts 32 extending in the optical direction and the pillars 35 connecting the lower ends of the posts 32. This increases the strength that acts against the winding pressure when the coil 60 is wound as compared with the prior art. This suppresses inward deformation of the posts 32 when winding force is generated by winding a coil as compared with the prior art.

(2) In the present embodiment, the posts 32 include the hooking portion 36, which hooks an end of the coil 60. This easily hooks the end 61 of a wound coil 60 to the posts 32. Accordingly, unwinding of the coil 60 is suppressed, and the electromagnetic driving force generated by the coil 60 can be stabilized. Further, the end 61 can easily be connected to the terminal 39 arranged on the basal portion 31 in the vicinity of the hooking portion 36.

(3) In the present embodiment, the holder 10 is molded integrally with the magnets 20. Thus, in comparison with when bonding the magnets 20 and holder 10 with an adhesive, the bonding strength of the magnets 20 and holder 10 can be increased. Integral molding of the holder 10 and the magnets 20 can easily be facilitated by, for example, injection molding a resin material. Thus, a process of coupling the magnets 20 can be eliminated, and costs may be reduced.

(4) The camera module of the present embodiment includes the lens driving device 1. The lens driving device 1 directly winds a conductive wire to the posts 32 of the basal portion 31. Thus, the lens driving device 1 has high accuracy. Further, the lens driving device 1 suppresses inward deformation of the posts when the winding of a conductive wire generates a winding pressure. Thus, the winding accuracy of the conductive wire does not decrease. Accordingly, a camera module including the lens driving device 1 has high accuracy.

(5) The cellular phone of the present embodiment includes the above-described camera module. The camera module is compact and highly accurate. Thus, the camera module is optimal for use in a cellular phone.

The present invention is not limited to the embodiments described above and may be modified as described below.

In the above embodiment, the magnets 20 are arranged in advance in a mold for molding the holder 10, and the holder and magnets are molded integrally at the same time as when injection molding is performed. However, another structure may be used. For example, when there are manufacturing limitations or the like, the magnets 20 may be coupled after formation of the holder 10.

In the above embodiment, the posts 23 of the lens driving device 1 include the hook-shaped hooking portion 36, which hooks the end 61 of the coil 60. It is only required that the end 61 of the coil 60 be hooked. Thus, the hooking portion 36 may have the shape of, for example, a projection, a notch, a recess that can receive the end, or the like. When there is no need to particularly change the winding direction of the coil 60 or when there is no need to change the winding direction of the coil 60, the direction changing portion 37 may be eliminated thereby reducing costs.

In the above embodiment, the lens driving device is arranged in a camera module but may be used in other forms. For example, the lens driving device may be installed in other optical devices, such as a telescope, a microscope, a binocular, and the like to add an autofocusing function to the optical device.

In the above embodiment, the camera module is arranged in a cellular phone but may be used in other forms. The camera module may be arranged in a compact digital camera, a digital single-lens reflex camera, or a camera for silver salt photography. Further, the camera module may be arranged in a digital video camera for recording moving pictures or a film camera.

### DESCRIPTION OF REFERENCE CHARACTERS

1: lens driving device
1a: lens module
1b: fixed body
2: filter
3: image sensor
4: Hall element
5: CPU
6: driver
9: cover glass
10: holder
11: optical lens
12: lens barrel
13: lens unit
20: magnet
30: base
31: basal portion
32: post
32a: end
33: opening
35: pillar
36: hooking portion
37: direction changing portion
39: terminal
40: case
41: through hole
50: shaft
60: coil
61: end
70: magnetic plate
81: display unit
82: operation unit
110: holder
113: lens unit
115: shaft hole
116: shaft hole
120: magnet
130: base
132: post
160: coil
H: hinge

1. A lens driving device comprising:
a holder that holds a lens unit, wherein the holder is movable in an optical axis direction of the lens unit;
a magnet that surrounds the lens unit in a radial direction of the lens unit, wherein the magnet is fixed to the holder;
a coil that surrounds the holder in the radial direction, wherein the coil faces the magnet in the radial direction;
a plurality of posts surrounding the holder in the radial direction, wherein the plurality of posts to which the coil is wound extend in the optical axis direction; and
a beam connecting ends of the posts facing the same direction in the optical axis direction with each other, wherein the beam is connected to each end of the plurality of posts.

2. The lens driving device according to claim 1, wherein the posts include a hooking portion that hooks an end of the coil.

3. The lens driving device according to claim 1, wherein the posts include a direction changing portion that changes a winding direction of the coil.

4. The lens driving device according to claim 1, wherein the holder is molded integrally with the magnet.

5. A camera module including the lens driving device according to claim 1.

6. A cellular phone including the camera module according to claim 5.
